(19) United States
(12) Patent Application Publication
(10) Pub. No.: US 2017/0071053 A1
(43) Pub. Date: Mar. 9, 2017

(54) DEVICE FOR FEEDING HIGH-FREQUENCY POWER AND SUBSTRATE PROCESSING APPARATUS HAVING THE SAME

(71) Applicant: AP SYSTEMS INC., Hwaseong-Si (KR)

(72) Inventors: Jae Seung LEE, Suwon-Sii (KR); Chang Won LEE, Daejeon (KR)

(21) Appl. No.: 15/220,387

(22) Filed: Jul. 26, 2016

(30) Foreign Application Priority Data
Sep. 3, 2015 (KR) 10-2015-0125030

(51) Int. Cl. H05H 1/46

(52) U.S. Cl. CPC H05H 1/46; H05H 2001/4645

(57) ABSTRACT

The present disclosure relates to a device for feeding high-frequency power and a substrate processing apparatus having the same, and more particularly, to a device for feeding high-frequency power, in which a matcher is integrated with a power divider and a substrate processing apparatus having the same. The device for feeding high-frequency power includes an input unit into which high-frequency power is inputted from a high-frequency power source, a plurality of output units in which the high-frequency power inputted into the input unit is divided and outputted, a plurality of variable capacitors connected between a division point at which the high-frequency power is divided and the plurality of output units, respectively, and a second variable capacitor connected between the input unit and the division point.

### CROSS-REFERENCE TO RELATED APPLICATION

This application claims priority to Korean Patent Application No. 10-2015-0125030 filed on Sep. 3, 2015 and all the benefits accruing therefrom under 35 U.S.C. §119, the contents of which are incorporated by reference in their entirety.

### BACKGROUND

The present disclosure relates to a device for feeding high-frequency power and a substrate processing apparatus having the same, and more particularly, to a device for feeding high-frequency power, in which a matcher is integrated with a power divider and a substrate processing apparatus having the same.

Equipment such as a plasma enhanced chemical vapor deposition (PECVD) device and a dry etcher use a radio frequency (RF) generator as a power source device for generating plasma. Here, to transmit all power from the RF generator to a plasma generating source, the matcher is used together with the RF generator. That is, one combination of the RF generator and the matcher is used for one plasma generator. If a plurality of plasma generators are used for processes, a plurality of RF generators and matchers have to be used. As a result, a configuration of the device may be complicated, and costs for manufacturing the process equipment may increase.

To solve the above-described limitations, a method in which a power divider is used to reduce the number of RF generators and matchers has been proposed. However, the typical method using the power divider may be a method in which the power divider is additionally used in the combination of the RF generator and the matcher. Since the fixed power divider does not have an automatic matching function, it takes a long time to secure a matching value. On the other hand, since the automatic power divider has the automatic matching function, the power divider is expensive. That is to say, since a capacitor in the fixed power divider is not adjusted in capacity and thus has to be replaced to adjust a process variable, it takes a long time to secure a matching value. Since the automatic power divider uses a plurality of variable capacitors, the power divider is expensive.

### PRIOR ART DOCUMENTS

### Patent Documents

Korean Patent Publication No. 10-2013-0047532 A

### SUMMARY

The present disclosure provides a device for feeding high-frequency power in which duplicated elements of a matcher and a power divider are omitted to integrate the matcher with the power divider and a substrate processing apparatus.

In accordance with an exemplary embodiment, a device for feeding high-frequency power includes: an input unit into which high-frequency power is inputted from a high-frequency power source; a plurality of output units in which the high-frequency power inputted into the input unit is divided and outputted; a plurality of variable capacitors connected between a division point at which the high-frequency power is divided and the plurality of output units, respectively; and a second variable capacitor connected between the input unit and the division point.

The plurality of first variable capacitors may be connected in series to the plurality of output units, respectively, and the second variable capacitor may be disposed to be shunted at a circuit between the input unit and the division point.

The device for feeding high-frequency power may further include a control unit configured to control the plurality of first variable capacitors or the second variable capacitor so that reflected power to the high-frequency power source has a preset power value.

The control unit may include: a power value set part configured to set the reflected power, which flows to the high-frequency power source, to a desired value; a plurality of first control part configured to control the plurality of first variable capacitors; and a second control part configured to control the second variable capacitor.

The control unit may further include an output value set part configured to set an output voltage value or an output current value to a desired value.

The control unit may control each of the plurality of first variable capacitors through each of the plurality of first control parts so that the output voltage or the output current of the output unit has a voltage value or a current value that is previously set to the output value set part.

The control unit may further include an offset set part configured to set an offset value of capacitance of the rest first variable capacitor with respect to at least one first variable capacitor of the plurality of first variable capacitors.

The control unit may control the plurality of first variable capacitors or the second variable capacitor by measuring phases of a voltage and current of the input unit.

The device for feeding high-frequency power may further include a first sensor electrically connected to the input unit to measure at least one of a voltage, current, phases of the voltage and the current, and reflected power to the high-frequency power source.

The device for feeding high-frequency power may further include a plurality of second sensors respectively electrically connected to the plurality of output units to measure an output voltage or output current of each of the plurality of output units.

The device for feeding high-frequency power may further include a first inductor or a first capacitor connected between the input unit and the division point.

The device for feeding high-frequency power may further include a second inductor or a second capacitor connected between each of the plurality of output units and the division point.

The device for feeding high-frequency power may further include a third inductor or a third capacitor connected to the second variable capacitor.

In accordance with another exemplary embodiment, a substrate processing apparatus includes: the device for feeding the high-frequency power in accordance with an exemplary embodiment; a high-frequency power source connected to an input unit of the device for feeding the high-frequency power to input high-frequency power into the input unit; and a plurality of electrodes connected to a plurality of output units of the device for feeding the high-frequency power to generate plasma by using the high-frequency power outputted from the output units.

The substrate processing apparatus may further include a plurality of deposition sources to which the plurality of electrodes are respectively provided, being configured to supply a plasma source onto a substrate by using the plasma generated by the plurality of electrodes.

The device for feeding the high-frequency power may feed an independent output voltage or output current to each of the plurality of electrodes.

In accordance with yet another exemplary embodiment, a substrate processing apparatus includes: a high-frequency power source configured to supply high-frequency power; a device for feeding high-frequency power connected to the high-frequency power source to receive the high-frequency power and including a plurality of first variable capacitors connected in parallel to each other to divide the high-frequency power inputted from the high-frequency power source and a second variable capacitor connected to a front end of a division point at which the high-frequency power is divided; a plurality of electrodes connected to a plurality of output units of the device for feeding the high-frequency power and configured to generate plasma by using the high-frequency power outputted from the output units; and a plurality of linear deposition sources disposed in parallel to each other in a first direction and supplying a plasma source onto a substrate by using the plasma generated by the plurality of electrodes, which are respectively provided to the plurality of linear deposition sources, wherein the device for feeding the high-frequency power further includes a control unit configured to measure reflected power to the high-frequency power source by measuring a voltage, current, and phases of the voltage and the current in an input unit into which the high-frequency power is inputted and configured to minimize the reflected power to the high-frequency power source by controlling the plurality of first variable capacitors.

The substrate processing apparatus may further include: a substrate support unit by which the substrate is supported; and a driving unit configured to move the substrate support unit in a second direction crossing the first direction.

### BRIEF DESCRIPTION OF THE DRAWINGS

Exemplary embodiments can be understood in more detail from the following description taken in conjunction with the accompanying drawings, in which:

FIG. 1 is a circuit diagram of a device for feeding high-frequency power in accordance with an exemplary embodiment;

FIG. 2 is a circuit diagram illustrating a first modified example of the device for feeding the high-frequency power in accordance with an exemplary embodiment;

FIG. 3 is a smith chart for explaining variable impedance matching in accordance with an exemplary embodiment;

FIG. 4 is a circuit diagram illustrating a second modified example of the device for feeding the high-frequency power in accordance with an exemplary embodiment;

FIG. 5 is a conceptual view for explaining a variation in matching area depending on a matching system in the device for feeding the high-frequency power in accordance with an exemplary embodiment; and

FIG. 6 is a schematic view of a substrate processing apparatus in accordance with another exemplary embodiment.

### DETAILED DESCRIPTION OF EMBODIMENTS

Hereinafter, specific embodiments will be described in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the descriptions, the same elements are denoted with the same reference numerals. In the figures, the dimensions of layers and regions are exaggerated for clarity of illustration. Like reference numerals refer to like elements throughout.

FIG. 1 is a circuit diagram of a device for feeding high-frequency power in accordance with an exemplary embodiment.

Referring to FIG. 1, a device 100 for feeding high-frequency power in accordance with an exemplary embodiment may include an input unit 110 into which the high-frequency power is inputted, a plurality of output units 120 through which the inputted high-frequency power is divided and outputted, a plurality of first variable capacitors 130 connected between a division point 21 at which the high-frequency power is divided and each of the plurality of output units 120, and a second variable capacitor 140 connected between the input unit 110 and the division point 21.

The input unit 110 may be connected to a high-frequency power soured, and the high-frequency power may be inputted into the input unit 110. Here, the high-frequency power may be a radio frequency (RF) generator.

In the output units 120, the high-frequency power inputted into the input unit 110 may be matched and outputted. The output units 120 may be connected to an electrode (not shown), which generates plasma, of a plasma generator. Here, the output units may be provided in plurality in accordance with the number of plasma generators. The high-frequency power inputted into the input unit 110 may be divided and transmitted to each of the plasma generators through each of the output units 120.

The first variable capacitors 130 may be connected between the input unit 110 and the output units 120. Here, the first variable capacitors 130 may be connected in series to a circuit or shunted at the circuit and then connected. The first variable capacitors 130 may be connected in series or parallel to the output units 120. Here, the shunted circuit may be grounded. The first variable capacitors 130 may be provided in plurality. The first variable capacitors 130 may be disposed to correspond to the plurality of output units 120, respectively. The plurality of first variable capacitors 130 may be connected between the division point 21 at which the high-frequency power is divided and each of the plurality of output units 120. Also, the plurality of first variable capacitors 130 may adjust an output voltage or output current outputted to the output units 121 and 122 that are respectively electrically connected thereto.

The second variable capacitor 140 may be connected between the input unit 110 and the division point 21. Here, the second variable capacitor 140 may be connected in series between the input unit 110 and the division point 21 or connected in parallel and disposed to be shunted at the circuit between the input unit 110 and the division point 21. When the second variable capacitor 140 is controlled, reflected power from the input unit 110 to the high-frequency power source may be adjusted.

Also, the plurality of first variable capacitors 130 may be respectively connected in series to the plurality of output units 120, and the second variable capacitor 140 may be disposed to be shunted at the circuit between the input unit 110 and the division point 21. In this case, the plurality of first variable capacitors 130 may have one voltage, and the second variable capacitor 140 may have one voltage. Thus, the same voltage may be applied to the plurality of first variable capacitors 130 and the second variable capacitor 140 with respect to the division point 21 or a shunt point 31 of the second variable capacitor 140. That is, a mean voltage of the plurality of first variable capacitors 130 and the voltage of the second variable capacitor 140 may be the same. Thus, a variation in phase of the voltage of the input unit 110 may be easily predicted. To minimize the reflected power to the high-frequency power source, the plurality of first variable capacitors 130 or the second variable capacitor 140 may be controlled to easily perform matching of an impedance in consideration of only the current (or a variation in phase of the current) of the input unit 110.

The device for feeding the high-frequency power 100 may further include a control unit (not shown) for controlling the plurality of first variable capacitors 130 or the second variable capacitor 140 so that the reflected power to the high-frequency power source has a preset power value.

The control unit (not shown) may control the plurality of first variable capacitors 130 or the second variable capacitor 140 to perform impedance matching of the plasma generators that are respectively connected to the output units 120. Here, the control unit may control the plurality of first variable capacitors 130 or the second variable capacitor 140 so that the reflected power to the high-frequency power source has the preset power value.

The control unit (not shown) may include a power value set part (not shown) for setting the reflected power, which flows to the high-frequency power source, to a desired value, a plurality of first control part (not shown) for controlling the plurality of first variable capacitors 130, and a second control part (not shown) for controlling the second variable capacitor 140.

The power value set part (not shown) may previously set a desired power value (or a reflected power value) so that the reflected power from the input unit 110 to the high-frequency power source has a desired value. When the power value is set in the power value set part, the plurality of first control parts (not shown) and second control parts (not shown) may control the plurality of first variable capacitors 130 or the second variable capacitor 140 so that the value of the reflected power from the input unit 110 to the high-frequency power source has a preset power value. Here, the plurality of first control parts (not shown) may control the plurality of first variable capacitors 130, and the second control part (not shown) may control the second variable capacitor 140.

The power value may be set to ‘0’ in the power value set part. When the reflected power from the input unit 110 to the high-frequency power source has a value of ‘0’, all power from the high-frequency power source may be transmitted to the plasma generator. In this case, the high-frequency power source may be efficiently used. If it is intended that the reflected power from the input unit 110 to the high-frequency power source has a value of ‘0’, an impedance in the input unit 110 has to have a value of 50+0 jΩ. Also, since the power value that is previously set in the power value set part is changeable as occasion demands, and it is difficult to allow the reflected power to accurately match a value of ‘0’, the power value may approach ‘0’, and the reflected power from the input unit 110 to the high-frequency power source may be minimized.

As described above, the control unit may set the power value to the power value set part to adjust (or control) the plurality of first variable capacitors 130 or the second variable capacitor 140, thereby allowing the reflected power from the input unit 110 to the high-frequency power source to have the set power value and performing automatic matching with the plasma generator.

Also, the control unit may further include an output value set part (not shown) for setting an output voltage value or output current value of each of the output unit 120.

The output value set part (not shown) may previously set a desired output value so that an output voltage or output current of the output unit 120 has the desired value. When the desired output value is previously set in the output value set part, the control unit may control each of the plurality of first variable capacitors 130 through the plurality of first control parts so that the output voltage or output current of the output unit 120 match the voltage value or current value that is previously set in the output value set part. The high-frequency power is outputted through the output unit 120 and then transmitted to the electrode, which generates plasma, of the plasma generator. Here, a voltage may be applied to the electrode to generate plasma. The intensity of the plasma is proportional to the intensity of the voltage. If the output voltage of the output unit 120 is high, the intensity of the plasma may increase. Also, since the voltage is proportional to the current, the more the output current of the output unit 120 increases, the more the output voltage of the output unit 120 may increase.

Thus, the voltage value or current value may be set in the output value set part so that the output voltage or output current is maximized. The control unit may control each of the plurality of first variable capacitors 130 through the plurality of first control parts so that the output voltage or output current of each of the output units 120 is maximized. However, an exemplary embodiment is not limited to the voltage value or current value that is set in the output value set part. For example, the voltage value or current value may be changed as occasion demands. Also, the control unit may control each of the plurality of first variable capacitors 130 through the plurality of first control parts so that the output voltage or output current of each of the output unit 120 has the voltage value or current value that is set in the output value set part. Here, the plurality of first variable capacitors 130 may be controlled so that the plurality of first variable capacitors 130 have the same value. Referring to FIG. 1 as an example, while the plurality of first variable capacitors 131 and 132 respectively connected to the plurality of output units 121 and 122 are controlled so that the plurality of first variable capacitors 131 and 132 have the same value, the reflected power from the input unit 110 to the high-frequency power source may be minimized.

Also, the control unit may further include an offset set part (not shown) for setting an offset value of capacitance of the rest first variable capacitor 132 or 131 with respect to at least one first variable capacitor 131 or 132 of the plurality of first variable capacitors 130.

If the output voltages and output currents of the output units 120 are different from each other, the output voltages and output currents of the output units 120 may be adjusted to the same value or values different from each other as occasion demands. Here, the offset set part (not shown) may set an offset value with respect to at least one first variable capacitor 131 or 132 of the plurality of first variable capacitor 130 to adjust the capacitance of the rest first variable capacitor 132 or 131. Thus, the output voltage and output current of each of the output units 120 may be adjustable. Here, the offset value may be inputted to a ratio (±x %) of the capacitance value. For example, when two output units 120 are provided, the first variable capacitor 130 is connected to each of the output units 120, and the offset value is inputted to a value of +5%, the first variable capacitor 131 may be a 500 pF variable capacitor. Also, when the capacitance becomes 150 pF (30%) at some time, the other first variable capacitor 132 may have capacitance of 175 pF (35%). As described above, the rest first variable capacitor 132 or 132 with respect to one first variable capacitor 131 or 132 may be adjusted in capacitance through the offset set part to simply adjust the output voltage and output current of each of the output units 120.

Also, when the matching is performed, an offset value between the plurality of first variable capacitors 130 may be set to adjust the plurality of first variable capacitors 130 in a state in which a predetermined ratio is maintained between the plurality of first variable capacitors 130. Thus, even when the output voltage and output current of each of the output units 120 are different as occasion demands, the matching may be easily quickly performed, like the case in which the output voltages and output currents of the output units 120 are the same.

Thus, the output voltage and output current of each of the output units 120 may be different as occasion demands so that the intensity of the plasma generated in each of the plasma generators is different. In this case, the matching may be easily quickly performed.

Also, the control unit may control the plurality of first variable capacitors 130 or the second variable capacitor 140 by measuring phases of a voltage and current of the input unit 110. The intensity of the reflected power from the input unit 110 to the high-frequency power source may be confirmed by a phase difference between the voltage and the current of the input unit 100. For example, if a phase difference between the voltage and the current of the input unit 110 is ‘0’, the reflected power from the input unit 110 to the high-frequency power source becomes ‘0’. Thus, the phases of the voltage and the current of the input unit 110 may be measured to confirm the phase difference between the voltage and the current of the input unit 110 and control the plurality of first variable capacitors 130 or the second variable capacitor 140, thereby minimizing the reflected power from the input unit 110 to the high-frequency power source.

When the reflected power from the input unit 110 to the high-frequency power source is adjusted to be minimized, the plurality of first variable capacitors 130 or the second variable capacitor 140 may be controlled at the same time. Here, the plurality of first variable capacitors 130 may be controlled to have the same value. Also, a voltage, current, and a phase in the input unit 110 may be measured in real time to control the plurality of first variable capacitors 130 or the second variable capacitor 140. Here, the voltage, the current, and the phase in the input unit 110 may be compared to control the plurality of first variable capacitors 130 and/or the second variable capacitor 140 so that the plurality of first variable capacitors 130 and/or the second variable capacitor 140 have fixed values in accordance with the measured values of the voltage, the current, and the phase. Here, the fixed values may be values (for example, a lookup table) that are previously stored through the experiment.

Also, when the voltage values and/or the current values of the output units 120 after the reflected power to the high-frequency power source is adjusted to be minimized are different from each other, the plurality of first variable capacitors 130 respectively connected to the plurality of output units 120 may be controlled so that all the voltage values and the current values of the output units 120 are the same. Also, the voltage value or the current value of each of the output units 120 are adjusted to have a desired ratio to adjust the voltage values or the current values of the output units 120 so that the voltage values or the current values of the output units 120 are different from each other. As described above, since each of the plurality of first variable capacitors 130 is related to one output unit 120, the voltage value or the current value of each of the output units 120 may be simply adjusted. As occasion demands, the output unit 120 may be controlled to adjust the voltage value and/or the current value of the output unit 120.

The device 100 for feeding the high-frequency may further include a first sensor 150 electrically connected to the input unit 110 to measure at least one of a voltage, current, phases of the voltage and the current, and reflected power to the high-frequency power source.

The first sensor 150 may be electrically connected to the input unit 110. When the second variable capacitor 140 is connected in series, the first sensor 150 may be disposed between the input unit 110 and the second variable capacitor 140. When the second variable capacitor 140 is shunted and connected in parallel, the first sensor 150 may be disposed between the shunt point 31 at which the second variable capacitor 140 is shunted and the input unit 110.

Also, the first sensor 150 may measure at least one of the voltage, the current, the phases of the voltage and the current, and the reflected power to the high-frequency power source at a fixed position thereof. Alternatively, the first sensor 150 may be disposed on the input unit 110 to measure at least one of an input voltage, input current, phases of the input voltage and the input current, and the reflected power to the high-frequency power source of the input unit 110. The plurality of first variable capacitors 130 or the second variable capacitor 140 may be controlled so that the reflected power from the input unit 110 to the high-frequency power source is minimized while confirming the reflected power from the input unit 110 to the high-frequency power source, which is measured by the first sensor 150. Here, the reflected power from the input unit 110 to the high-frequency power source may be measured by measuring and calculating a voltage, current, and phases (that is, the voltage, the current, and the phases of the voltage and the current in the input unit) at a position of the first sensor 150 by using the first sensor 150. When a phase difference between the voltage and the current is ‘0’, it may be determined that the reflected power does not exist. Also, the first sensor 150 may measure the reflected power from the input unit 110 to the high-frequency power source by using a difference between the power value of the high-frequency power source and the input power of the input unit 110.

Thus, the reflected power from the input unit 110 to the high-frequency power source may be measured to control the plurality of first variable capacitors 130 or the second variable capacitor 140 so that the reflected power from the input unit 110 to the high-frequency power source is minimized Therefore, the impedance matching of the plasma generator connected to each of the output unit 120 may be performed. Here, the plurality of first variable capacitors 130 or the second variable capacitor 140 may be manually controlled or automatically controlled by using the control unit (not shown) to perform the impedance matching of the plasma generator connected to each of the output unit 120.

The device 100 for feeding the high-frequency may further include a plurality of second sensors 160 electrically connected to each of the plurality of output units 120 to measure an output voltage or output current of each of the plurality of output units 120.

The plurality of second sensors 160 may be electrically connected to the output units 120, respectively. Also, the plurality of second sensors 160 may be disposed between the plurality of first variable capacitors 130 and the plurality of output units 120, respectively. Also, the plurality of second sensors 160 may compare a difference in electrical characteristic of the output units 120. That is, the plurality of second sensors 160 may measure an output voltage and output current of each of the plurality of output units 120. In the plasma generator, a voltage may be applied to the electrode for generating plasma to generate plasma. Here, since the intensity of the plasma is proportional to the intensity of the voltage, the reflected power to the high-frequency power source is set to a value of ‘0’ to maximize the output voltage of the output unit 120 so that the output voltage of the output unit 120 increases to improve the intensity of the plasma. Here, since the voltage is proportional to the current, when the reflected power to the high-frequency power source becomes ‘0’, the output current of the output unit 120 may be maximized. Thus, each of the plurality of first variable capacitors 130 may be controlled so that the output voltage and/or the output current of each of the output unit 120 are maximized. As a result, the reflected power to the high-frequency power source may become ‘0’. Here, the plurality of first variable capacitors 130 or the second variable capacitor 140 may be controlled while confirming the output voltage or the output current of each of the output units 120 through the plurality of second sensors 160. Here, the plurality of first variable capacitors 130 may be controlled to be maintained to a predetermined ratio (for example, a ratio of 1:1 or an offset reflecting ratio). Also, when the values measured by the second sensors 160 are different from each other, the offset may be applied so that all the output voltage values or output current values of the output units 120 are the same. Here, the plurality of first variable capacitors 130 or the second variable capacitor 140 may be manually controlled or automatically controlled by using the control unit (not shown).

As described above, the plurality of first variable capacitors 130 or the second variable capacitor 140 may be controlled so that the reflected power from the input unit 110 to the high-frequency power source is minimized while confirming the reflected power from the input unit 110 to the high-frequency power source, which is measured by the first sensor 150. Also, the plurality of first variable capacitors 130 or the second variable capacitor 140 may be controlled while confirming the output voltage or the output current of each of the output units 120 through the plurality of second sensors 160 so that the output voltage or the output current of each of the output unit 120 is maximized to allow the reflected power to the high-frequency power source to have the value of ‘0’. Thus, the impedance matching of the plasma generator connected to each of the output unit 120 may be simply performed.

When the impedance matching is performed, the reflected power to the high-frequency power source may become ‘0’ to maximize the voltage of the output unit 120. In this state, unless the input power increases, even though the plurality of first variable capacitors 130 are controlled, the whole output voltage may not increase. For example, when the plurality of first variable capacitors 130 is controlled, only an output ratio of the output units 120 may be adjusted. For example, in case in which two output units 120 are provided, when power of 100 W is inputted, if the plurality of first variable capacitors 130 have the same value when the reflected power to the high-frequency power source matches ‘0’, power of 50 W may be outputted from each of the output units 120. Here, when one first variable capacitor 132 is controlled to change the two output values, the matching may break down to allow all the voltages of the plurality of first variable capacitors 130 to drop. This is done because the impedance matching is related to all of the plurality of first variable capacitors 130 and the second variable capacitor 140. Thus, the plurality of first variable capacitors 130 or the second variable capacitor 140 may be controlled for matching so that a phase difference between the voltage and the current in the first sensor 150 becomes ‘0’. As a result, all the plurality of first variable capacitors 130 may be equally controlled to have the same value. Thus, to adjust the output ratio to a desired value after the matching is performed, each of the first variable capacitors 130 may be offset in value to move. Here, the offset value may be an offset value of the plurality of first variable capacitors 130, and a value of the variable capacitor may be expressed as a % value in the total capacitance. The capacitance in the matcher and/or the power divider may be generally expressed as the % value. For example, if the variable capacitor of 500 pF is 30%, the present capacitance may be 150 pF. To adjust the output ratio to a desired value, the plurality of first variable capacitors 130 or the second variable capacitor 140 has to continuously move so that the offset value of each of the first variable capacitors 130 is maintained, and the reflected power to the high-frequency power source becomes 0 during the matching.

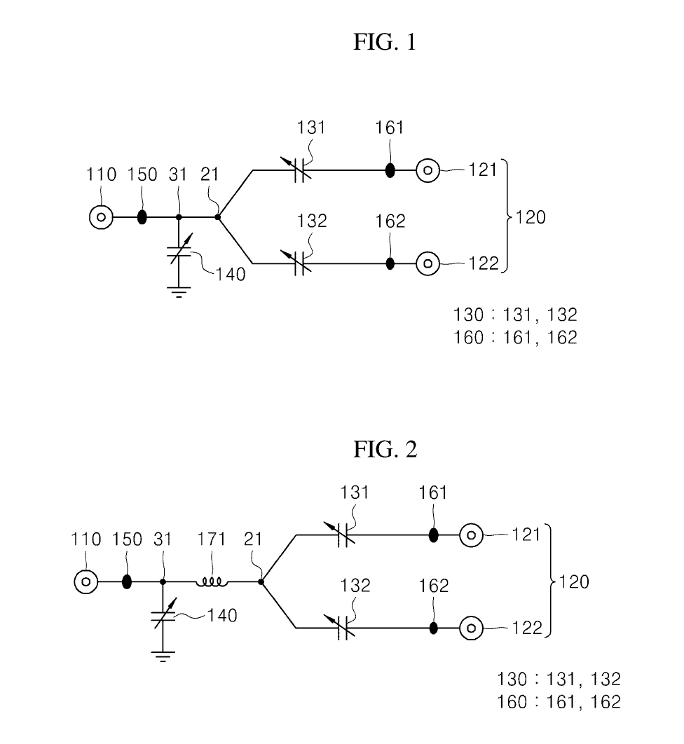

FIG. 2 is a circuit diagram illustrating a first modified example of the device for feeding the high-frequency power in accordance with an exemplary embodiment.

Referring to FIG. 2, the device 100 for feeding the high-frequency may further include a first inductor 171 or a first capacitor 171′ connected between the input unit 110 and the division point 21. The first inductor 171 or the first capacitor 171′ may be connected between the input unit 110 and the division point 21. For example, when the second variable capacitor 140 is connected in series, the first inductor 171 or the first capacitor 171′ may be connected between the second variable capacitor 140 and the division point 21. When the second variable capacitor 140 is shunted at the circuit and connected, the first inductor 171 or the first capacitor 171′ may be connected between the shunt point 31 at which the second variable capacitor 140 is shunted and the division point 21. Here, the first inductor 171 or the first capacitor 171′ may be connected in series to the circuit or shunted at the circuit and connected. Also, the first inductor 171 or the first capacitor 171′ may be adequately connected to the second variable capacitor 140 or one of a front end and a rear end of the shunt point 31 at which the second variable capacitor 140 is shunted as occasion demands. In this case, a matching range may move (or be changed). As described above, the matching range may be changed to restrict the matching movement, the matching range may move for matching to a point at which the impedance is 50+0 jΩ within a small range without moving to a wide range for matching.

Also, the first inductor 171 or the first capacitor 171′ may be provided in plurality. Alternatively, the first inductor 171 and the first capacitor 171′ may be used together. Here, the first inductors 171 or the first capacitors 171′ may be connected in series or parallel to each other in the same manner. Alternatively, the first inductors 171 or the first capacitors 171′ may be connected in series or parallel in a different manner. Here, the inductor or capacitor (kind), the series or parallel (connection manner), and the singular or plural (number) may be determined as occasion demands.

The first inductor 171 may be a fixed inductor or a variable inductor. Also, the first capacitor 171′ may be a fixed capacitor or a variable capacitor. As illustrated in FIG. 2, when the first inductor 171 is connected in series between the shunt points 31 and 21 to which the second variable capacitor 140 is connected in parallel, a type of matching system may be changed into an L-match type to allow the matching range to move. Also, when the plurality of first variable capacitors 130 are respectivley connected in series to the plurality of output units 120, and the second variable capacitor 140 is disposed to be shunted at the circuit between the input unit 110 and the division point 21, the type of matching system may be changed into the L-match type through the simple structure in which the fixed inductor (i.e., a first inductor) is additionally connected in series between the shunt point 31 and the division point 21.

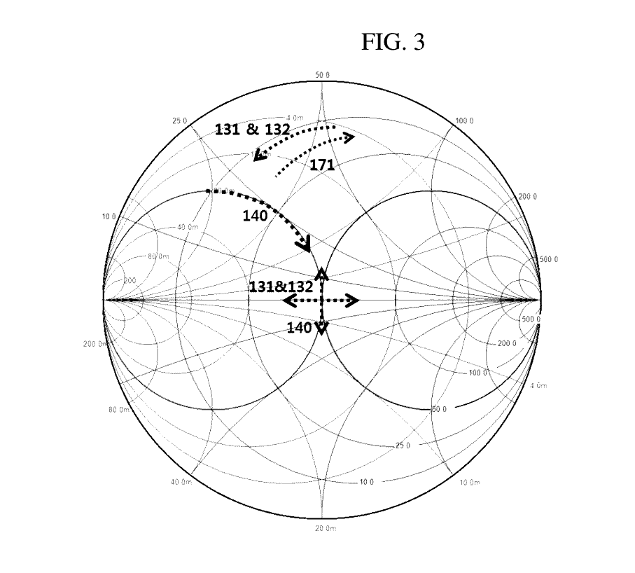

FIG. 3 is a smith chart for explaining variable impedance matching in accordance with an exemplary embodiment. That is, FIG. 3 illustrates an impedance matching concept when viewed from the first sensor 150 toward the output unit 120.

Referring to FIG. 3, it is confirmed that impedance matching is performed through the control of the plurality of first variable capacitors 131 and 132 and the second variable capacitor 140. In the smith chart of FIG. 3, a center point may be a point at which the reflected power from the input unit 110 to the high-frequency power source is ‘0’, and a phase of the high-frequency power in the input unit 110 is ‘0’. Thus, the plurality of first variable capacitors 131 and 132 or the second variable capacitor 140 may be controlled to move the impedance to the point (or the center point). The first inductor 171 connected in series between the shunt point 31 and 21 to which the second variable capacitor 140 is connected in parallel may move the impedance in a direction opposite to that of the plurality of variable capacitors 131 and 132.

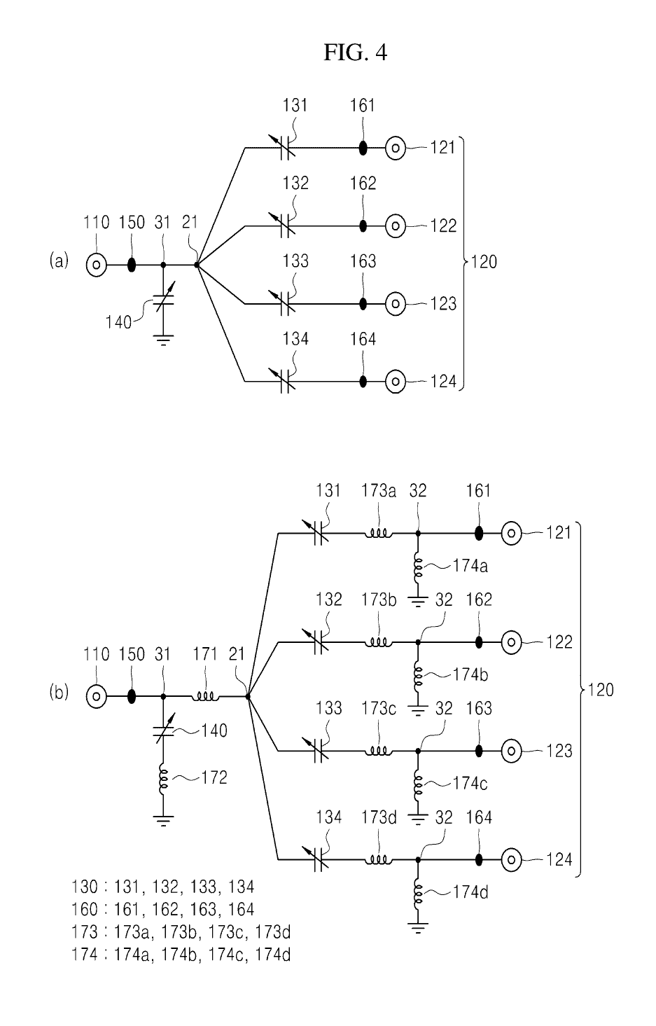

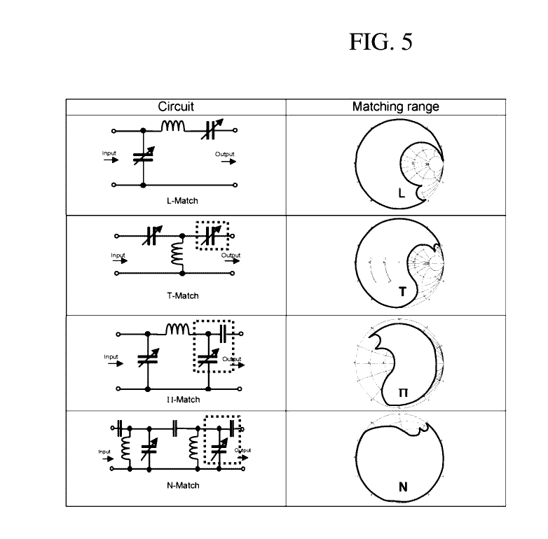

FIG. 4 is a circuit diagram illustrating a second modified example of the device for feeding the high-frequency power in accordance with an exemplary embodiment. (a) of FIG. 4 is a view illustrating a state in which the number of output units increases in the basic structure, and (b) of FIG. 4 is a view illustrating a state in which four output units are provided in the structure in which the inductors are connected in series and parallel.

Referring to FIG. 4, in the device 100 for feeding the high-frequency, the number of output units 120 may be freely adjusted in at least two or more. The number of output units 120 may be adjusted through the structure in which the first variable capacitors 133 and 134 arranged in parallel are added. If the first variable capacitors 133 and 134 arranged in parallel are added, since the output units 123 and 124 are capable of being added, and the automatic matching function is capable of being performed, the number of output units 120 may be freely adjusted.

The device 100 for feeding the high-frequency may further include a second inductor 173 or 174 or a second capacitor 173′ or 174′ connected between the plurality of output units 120 and the division point 21. The second inductor 173 or 174 or the second capacitor 173′ or 174′ may be connected between the plurality of output units 120 and the division point 21. For example, when the first variable capacitor 130 is connected in series, the second inductor 173 or 174 or the second capacitor 173′ or 174′ may be connected between each of the first variable capacitors 130 and the output unit 120. When the plurality of first variable capacitors 130 are shunted at the circuit and connected, the second inductor 173 or 174 or the second capacitor 173′ or 174′ may be connected between a plurality of shunt points (not shown) at which the first variable capacitors 130 are shunted and the output part 120 or between the division point 21 and the plurality of division. Here, the second inductor 173 or 174 or the second capacitor 173′ or 174′ may be connected in series to the circuit or shunted at the circuit and connected. Also, the second inductor 173 or 174 or the second capacitor 173′ or 174′ may be adequately connected to the plurality of first variable capacitors 130 or one of a front end and a rear end of the shunt point 31 at which each of the first variable capacitors 130 is shunted as occasion demands. Thus, a type of matching may be changed.

Also, the second inductor 173 or 174 or the second capacitor 173′ or 174′ may be provided in plurality. Alternatively, the second inductor 173 or 174 and the second capacitor 173′ or 174′ may be used together. Here, the second inductors 173 or 174 or the second capacitors 173′ or 174′ may be connected in series or parallel in the same manner. Alternatively, the second inductors 173 or 174 or the second capacitors 173′ or 174′ may be connected in series or parallel in a different manner. Here, the inductor or capacitor (kind), the series or parallel (connection manner), and the singular or plural (number) may be determined as occasion demands.

For example, as illustrated in (b) of FIG. 4, one second inductor 173 may be connected in series between the first variable capacitor 130 and the output unit 120, and the other second inductor 174 may be shunted and connected in parallel between the second inductor 173 and the output unit 120. In this case, the second inductor 173 or 174 may be connected in series or parallel to the plurality of first variable capacitors. As described above, the second inductor 173 or 174 or the second capacitor 173′ or 174′ may be additionally connected to in series or parallel to the first variable capacitor 130. Here, the second inductors 173 or 174 or the second capacitors 173′ or 174′ may be connected in series and parallel manners. Alternatively, the second inductors 173 or 174 the second capacitors 173′ or 174′ may be connected in one manner of the series or parallel manners. Thus, the matching range may be changed through the above-described structure. When the inductor or the capacitor are added (connected) in series or parallel to each of the first variable capacitors 130, a moving direction of 131 & 132 (the first variable capacitor) of FIG. 3 may be affected, and thus, the matching range may be limited according to each characteristic.

The second inductor 173 or 174 may be a fixed inductor or a variable inductor. Also, the second capacitor 173′ or 174′ may be a fixed capacitor or a variable capacitor. Also, the inductor or capacitor may be added in series or parallel to all the first variable capacitors 130. Alternatively, the inductor or capacitor may be added in series or parallel to only a portion of the plurality of first variable capacitors 130. As occasion demands, the number of inductor or capacitor to be added may be adjusted.

The device 100 for feeding the high-frequency may further include a third inductor 172 or a third capacitor 172′ connected to the second variable capacitor 140. The third inductor 172 or the third capacitor 172′ may be connected in series or parallel to the second variable capacitor 140. Here, when the second variable capacitor 140 is connected in series, the third inductor 172 or the third capacitor 172′ may be connected in parallel to the second variable capacitor 140 only between the input unit 110 and the second variable capacitor 140. When the second variable capacitor 140 is shunted at the circuit and connected, the third inductor 172 or the third capacitor 172′ may be connected in parallel only between the shunt point 31 at which the second variable capacitor 140 is shunted and the second variable capacitor 140. Also, the third inductor 172 or the third capacitor 172′ may be adequately connected in series to the second variable capacitor 140 or one of the front end and the rear end of the shunt point 31 as occasion demands.

The inductor or the capacitor may be added in series or parallel to the second variable capacitor 140, and thus, the matching range may be changed. When the inductor or the capacitor are added (connected) in series or parallel to the second variable capacitors 140, a moving direction of 140 (the second variable capacitor) of FIG. 3 may be affected, and thus, the matching range may be limited according to each characteristic. Thus, the inductor or the capacitor may be added in series or parallel to the second variable capacitor 140 to change the matching range into a form different from that in which the inductor or the capacitor is connected to each of the first variable capacitors 130.

The third inductor 172 may be a fixed inductor or a variable inductor. Also, the third capacitor 172′ may be a fixed capacitor or a variable capacitor.

FIG. 5 is a conceptual view for explaining a variation in matching area depending on the matching system in the device for feeding the high-frequency power in accordance with an exemplary embodiment.

A type of basic matching system may be classified into four types as illustrated in FIG. 5 such as an L-match type, a T-match type, a i-Match type, and an N-match type. FIG. 2 illustrates a modified structure of the L-match type, and the L-match type has been described until now.

Referring to FIG. 5, the type of matching system may be changed into various types such as the T-match type, a i-Match type, and an N-match type in addition to the L-match type through the structure in which the inductor or the capacitor is added in series or parallel to the plurality of first variable capacitors 130 or the structure in which the inductor or the capacitor is added in series or parallel to the second variable capacitor 140. Since the matching range is changed as occasion demands to restrict the matching movement, the matching range may move for matching within a small range without moving to a wide range for matching. Thus, the matching system that is suitable for the plasma generator may be constructed.

When dotted line portions are disposed to overlap in parallel to each other, even though the type of matching system is changed, the number of output units 120 may be freely adjusted.

An impedance matching method of the plasma generator connected to the output unit 120 by using the device for feeding the high-frequency power 100 in accordance with an exemplary embodiment may described as follows.

First, the plurality of first variable capacitors 131 and 132 and the second variable capacitor 140 may be controlled while confirming the input voltage, the input current, and a phase in the input unit 110 so that the reflected power from the input unit 110 to the high-frequency power source is minimized Here, the plurality of first variable capacitors 131 and 132 may be equally controlled to have the same value.

Here, if the output voltages and the output currents of the output units 120 are different from each other, the output voltage and the output current of the rest output unit 122 with respect to at least one output unit 121 may vary by controlling the first variable capacitor 132 connected to the corresponding output unit 122 so that the output voltages and the output currents of all the output units 120 have the same value. When the control unit (not shown) is used, the offset value may be inputted as a value of ±x % to control the first variable capacitor 132 connected to the rest output unit 122 with respect to the first variable capacitor 131 connected to at least one output unit 121. For example, even when the offset value is inputted as +5%, if the first variable capacitor 131 connected to at least one output unit 121 is 33%, the first variable capacitor 132 connected to the rest output unit 122 is 38%. Also, a value of the variable capacitor is determined as % of a maximum value. For example, when the maximum value is 500 pF, 30% corresponds to 150 pF.

Also, if the output voltages and the output currents of the output units 120 are adjusted to values different from each other, the offset value of the rest output unit 122 may be inputted to adjust the output voltage and the output current of the rest output unit 122 with respect to at least one output unit 121 so that the output voltage and the output current have respectively desired ratios.

The reflected power from the input unit 110 to the high-frequency power source may be minimized by using only the second variable capacitor 140. In this case, since each of the second variable capacitor 140 and the plurality of first variable capacitors 131 and 132 depends on one variable, the high speed matching may be enabled. Here, the second variable capacitor 140 may depend on the reflected power from the input unit 110 to the high-frequency power source, and the plurality of first variable capacitors 131 and 132 may respectively depend on the output voltage values or the output current values of the output units 121 and 122 that are respectively connected to the plurality of first variable capacitors 131 and 132.

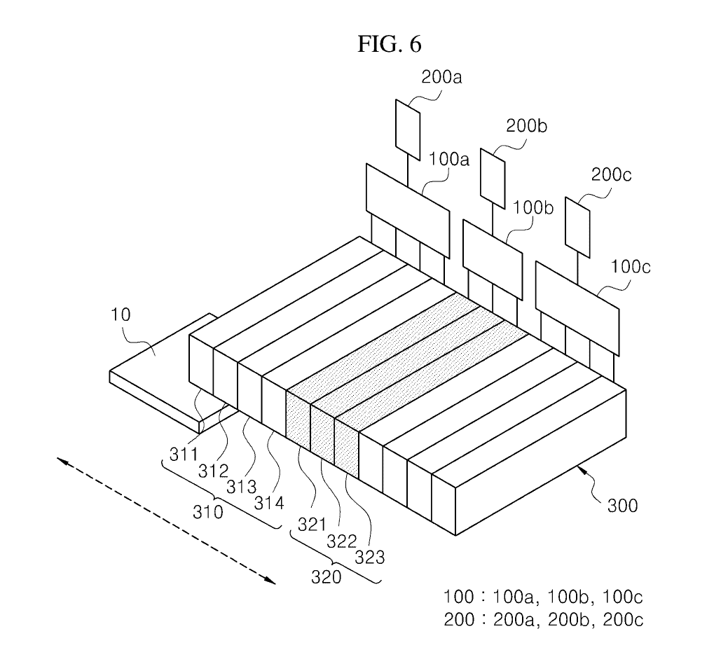

FIG. 6 is a schematic view of a substrate processing apparatus in accordance with another exemplary embodiment.

A substrate processing apparatus in accordance with another exemplary embodiment will be described with reference to FIG. 6. In the description of the substrate processing apparatus in accordance with another exemplary embodiment, duplicated descriptions with respect to the foregoing device for feeding the high-frequency will be omitted.

The substrate processing apparatus in accordance with another exemplary embodiment may include a device for feeding a high-frequency power 100 in accordance with an exemplary embodiment, a high-frequency power source 200 connected to an input unit of the device for feeding the high-frequency power 100 to input high-frequency power to the input unit, and a plurality of electrodes (not shown) connected to a plurality of output units of the device for feeding the high-frequency power 100 to generate plasma by using the high-frequency power outputted from the output units.

The device for feeding the high-frequency power 100 may be a device 100 for feeding the high-frequency in accordance with an exemplary embodiment as a power divider for automatically performing matching of each of plasma sources in a structure in which duplicated elements of the matcher and the power divider are omitted.

The high-frequency power source 200 may be connected to the input unit of the device 100 for feeding the high-frequency, and the high-frequency power may be inputted into the input unit. The high-frequency power supplied into the device for feeding the high-frequency power 100 through the input unit may be matched and divided in the device for feeding the high-frequency power 100.

The plurality of electrodes (not shown) may be connected to the output unit of the device 100 for feeding the high-frequency to generate plasma by using the high-frequency power outputted from the output unit. Here, the high-frequency power may be matched and divided in the device 100 for feeding the high-frequency according to impedance of each of the electrodes, and an output voltage and an output current of each of the electrodes may be differently divided.

The substrate processing apparatus may further include a plurality of deposition sources 300 for supplying a plasma source onto a substrate 10 by using plasma generated by the electrodes. Here, the plurality of electrodes may be provided to the plurality of deposition sources 300, respectively.

Generally, to generate the plasma on the plurality of deposition sources, a plurality of high-frequency power sources 200 and a plurality of matchers are necessary. Also, when the power divider is used to reduce the number of high-frequency power sources 200 and matchers, the matching may be difficult, or manufacturing costs of the power divider for performing the automatic matching may increase. Thus, to generate the plasma on the plurality of deposition sources in accordance with the related art, the plurality of high-frequency power sources 200 and the plurality of matchers may be used, or the power divider having the high manufacturing price may be used. As a result, manufacturing costs of the substrate processing apparatus may increase.

However, in an exemplary embodiment, the duplicated elements of the matcher and the power divider may be omitted, and the device for feeding the high-frequency power 100, in which the matching of each of the plasma sources is automatically performed, may be used to adequately match each of the deposition sources 310 or 320 and divide the high-frequency power by using a small number (e.g., one) of high-frequency power sources 200. Thus, the number of high-frequency power sources 200 and matchers that are required for generating the plasma on the plurality of deposition sources in accordance with the related art may be significantly reduced. Also, the device for feeding the high-frequency power 100 may be the power divider in which the duplicated elements of the matcher and the power divider are omitted, and the matching of each of the plasma sources is automatically performed. Thus, the power divider may be cheaper than the automatic power divider that is used together with the matcher in accordance with the related art to reduce the manufacturing costs of the substrate processing apparatus.

The plurality of deposition sources 300 may be a plurality of deposition sources 310 and 320 that are different from each other in a method for feeding the plasma source. In this case (for example, in case in which an encapsulation layer is formed), since a difference in impedance occurs according to the method for feeding the plasma source (for example, PEALD, PECVD, and the like), the same device for feeding the high-frequency power 100 may be used in the deposition sources that have impedance similar to each other and are similar to each other in the method for feeding the plasma source. For example, in case of a method for feeding two kinds of plasma sources that have a large difference in impedance, two devices 100 for feeding the high-frequency power may be used. However, an exemplary embodiment is not limited thereto. One device for feeding the high-frequency power 100 may be used for each group in which methods for feeding the plasma sources having impedances similar to each other are continuously performed.

The device for feeding the high-frequency power 100 may feed an independent output voltage or output current to each of the plurality of electrodes. Since the desired output voltage or output current is supplied to each of the electrodes, the plasma may be adequately generated in accordance with a kind or position of deposition source 300. Also, when a thin film deposition process is performed on the substrate 10, the plasma may be adequately generated in accordance with formation conditions of the thin film to be deposited.

Also, a control unit of the device for feeding the high-frequency power 100 may measure and calculate a voltage, current, and phases of the voltage and current in an output unit of the high-frequency power source 200 or an input unit 100 of the device for feeding the high-frequency power to measure reflected power to the high-frequency power source. To realize the matching of the plurality of deposition sources 300 through the device for feeding the high-frequency power 100, the reflected power to the high-frequency power source has to be confirmed. Here, the voltage, the current, and the phases of the voltage and current in the input unit 110 of the device for feeding the high-frequency power 100 may be measured and calculated to measure the reflected power to the high-frequency power source. The reflected power to the high-frequency power source may be measured through the above-described method to simply perform the matching of the plurality of deposition sources 300 through the device for feeding the high-frequency power 100. Thus, although the plurality of plasma sources are used, the power may be divided to match each of the plurality of plasma deposition sources 300 in accordance with each of the plasma sources, thereby effectively performing the substrate processing process in accordance with the process conditions.

A power value of the high-frequency power source 200 and an input power value of the input unit of the device for feeding the high-frequency power 100 source are compared to each other to measure the reflected power to the high-frequency power source by using a difference between the power value of the high-frequency power source 200 and the input power value of the input unit of the device for feeding the high-frequency power 100 source.

A substrate processing apparatus in accordance with further another exemplary embodiment will be described in more detail. In the description of the substrate processing apparatus in accordance with further another exemplary embodiment, duplicated descriptions with respect to the foregoing device for feeding the high-frequency power and the foregoing substrate processing apparatus will be omitted.

A substrate processing apparatus in accordance with further another exemplary embodiment may include a high-frequency power source supplying high-frequency power, a device for feeding high-frequency power connected to the high-frequency power source to receive the high-frequency power and including a plurality of first variable capacitors and connected in parallel to each other to divide the high-frequency power inputted from the high-frequency power source and a second variable capacitor connected to a front end of a division point at which the high-frequency power is divided, a plurality of electrodes connected to a plurality of output units of the device for feeding the high-frequency power to generate plasma by using high-frequency power outputted from the output units, and a plurality of linear deposition sources disposed in parallel to each other in a first direction to supply a plasma source onto a substrate by using the plasma generated by the plurality of electrodes, which are respectively provided to the plurality of linear deposition sources, wherein the device for feeding the high-frequency power measures reflected power to the high-frequency power source by measuring a voltage, current, and phases of the voltage and the current in an input unit, into which the high-frequency power is inputted, and to minimize the reflected power to the high-frequency power source by controlling the plurality of first variable capacitors or the second variable capacitor.

The duplicated elements of the matcher and the power divider in the exemplary embodiment may be omitted to use only the plurality of variable capacitors and the second variable capacitor. Also, the device for feeding the high-frequency power, which is capable of automatically performing the matching of each of the plasma sources through the control unit may be used. Thus, since the high-frequency power is divided by matching each of the linear deposition sources by using a small number (e.g., one) of high-frequency power sources, the number of high-frequency power sources and matchers, which are required for generating the plasma on the plurality of linear deposition sources in accordance with the related art, may be significantly reduced.

The substrate processing apparatus may further include a substrate support unit on which the substrate is supported and a driving unit moving the substrate support unit in a second direction crossing the first direction.

The substrate support unit supporting the substrate may be moved in the second direction crossing the first direction through the driving unit to allow the substrate to be moved to face the plurality of linear deposition sources. Thus, the thin film may be uniformly deposited on an entire area of the substrate.

As described above, since the duplicated elements of the matcher and the power divider in accordance with the related art are omitted to integrate the matcher with the power divider, the matching and power division of each of the plasma generator may be automatically performed by using one device. Thus, the number of high-frequency generators and matchers may be significantly reduced when compared to those of the high-frequency generators and matchers in accordance with the related art, and the overlapping device of the matcher and the power divider may be omitted to reduce the manufacturing costs of the process equipment. In addition, since the power is divided to match each of the plasma generators, the process stabilization may be secured. Also, the number of output units may be freely adjusted through the simple structure in which the first variable capacitor is parallely added, and each of the output units may be freely adjusted in output voltage or output current through the first variable capacitor connected to each of the output units. In the substrate processing apparatus in accordance with another exemplary embodiment, although the plurality of plasma sources are used, the power may be divided to match each of the plasma generators in accordance with each of the plasma sources, thereby effectively performing the substrate processing process in accordance with the process conditions.

In the device for feeding the high-frequency power in accordance with an exemplary embodiment, the duplicated elements of the matcher and the power divider in accordance with the related art may be omitted to integrate the matcher with the power divider, thereby automatically performing the matching and power division of each of the plasma generators by using one device.

Thus, the number of RF generators and matchers may be significantly reduced when compared to those of RF generators and matchers in accordance with the related art, and the duplicated elements of the matcher and the power divider may be omitted to reduce the manufacturing costs of the process equipment. In addition, since the power is divided to match each of the plasma generators, the process stabilization may be secured.

Also, the number of output units may be freely adjusted through the simple structure in which the first variable capacitor is parallely added, and each of the output units may be freely adjusted in output voltage or output current through the first variable capacitor connected to each of the output units.

In the substrate processing apparatus in accordance with another exemplary embodiment, although the plurality of plasma sources are used, the power may be divided to match each of the plasma generators in accordance with each of the plasma sources, thereby effectively performing the substrate processing process in accordance with the process conditions.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art. Hence, the real protective scope of the present invention shall be determined by the technical scope of the accompanying claims.

What is claimed is:

1. A device for feeding high-frequency power comprising:
an input unit into which high-frequency power is inputted from a high-frequency power source;
a plurality of output units in which the high-frequency power inputted into the input unit is divided and outputted;
a plurality of variable capacitors connected between a division point at which the high-frequency power is divided and the plurality of output units, respectively; and
a second variable capacitor connected between the input unit and the division point.

2. The device for feeding high-frequency power of claim 1, wherein the plurality of first variable capacitors are connected in series to the plurality of output units, respectively, and
the second variable capacitor is disposed to be shunted at a circuit between the input unit and the division point.

3. The device for feeding high-frequency power of claim 1, further comprising a control unit configured to control the plurality of first variable capacitors or the second variable capacitor so that reflected power to the high-frequency power source has a preset power value.

4. The device for feeding high-frequency power of claim 3, wherein the control unit comprises:
a power value set part configured to set the reflected power, which flows to the high-frequency power source, to a desired value;
a plurality of first control part configured to control the plurality of first variable capacitors; and
a second control part configured to control the second variable capacitor.

5. The device for feeding high-frequency power of claim 4, wherein the control unit further comprises an output value set part configured to set an output voltage value or an output current value to a desired value.

6. The device for feeding high-frequency power of claim 5, wherein the control unit controls each of the plurality of first variable capacitors through each of the plurality of first control parts so that the output voltage or the output current of the output unit has a voltage value or a current value that is previously set to the output value set part.

7. The device for feeding high-frequency power of claim 4, wherein the control unit further comprises an offset set part configured to set an offset value of capacitance of the rest first variable capacitor with respect to at least one first variable capacitor of the plurality of first variable capacitors.

8. The device for feeding high-frequency power of claim 3, wherein the control unit controls the plurality of first variable capacitors or the second variable capacitor by measuring phases of a voltage and current of the input unit.

9. The device for feeding high-frequency power of claim 1, further comprising a first sensor electrically connected to the input unit to measure at least one of a voltage, current, phases of the voltage and the current, and reflected power to the high-frequency power source.

10. The device for feeding high-frequency power of claim 1, further comprising a plurality of second sensors respectively electrically connected to the plurality of output units to measure an output voltage or output current of each of the plurality of output units.

11. The device for feeding high-frequency power of claim 1, further comprising a first inductor or a first capacitor connected between the input unit and the division point.

12. The device for feeding high-frequency power of claim 1, further comprising a second inductor or a second capacitor connected between each of the plurality of output units and the division point.

13. The device for feeding high-frequency power of claim 1, further comprising a third inductor or a third capacitor connected to the second variable capacitor.

14. A substrate processing apparatus comprising:
the device for feeding the high-frequency power of any one of claim 1;
a high-frequency power source connected to an input unit of the device for feeding the high-frequency power to input high-frequency power into the input unit; and
a plurality of electrodes connected to a plurality of output units of the device for feeding the high-frequency power to generate plasma by using the high-frequency power outputted from the output units.

15. The substrate processing apparatus of claim 14, further comprising a plurality of deposition sources to which the plurality of electrodes are respectively provided, being configured to supply a plasma source onto a substrate by using the plasma generated by the plurality of electrodes.

16. The substrate processing apparatus of claim 14, wherein the device for feeding the high-frequency power feeds an independent output voltage or output current to each of the plurality of electrodes.

17. A substrate processing apparatus comprising:
a high-frequency power source configured to supply high-frequency power;
a device for feeding high-frequency power connected to the high-frequency power source to receive the high-frequency power and comprising a plurality of first variable capacitors connected in parallel to each other to divide the high-frequency power inputted from the high-frequency power source and a second variable capacitor connected to a front end of a division point at which the high-frequency power is divided;
a plurality of electrodes connected to a plurality of output units of the device for feeding the high-frequency power and configured to generate plasma by using the high-frequency power outputted from the output units; and
a plurality of linear deposition sources disposed in parallel to each other in a first direction and supplying a plasma source onto a substrate by using the plasma generated by the plurality of electrodes, which are respectively provided to the plurality of linear deposition sources,
wherein the device for feeding the high-frequency power further comprises a control unit configured to measure reflected power to the high-frequency power source by measuring a voltage, current, and phases of the voltage and the current in an input unit, into which the high-frequency power is inputted, and configured to minimize the reflected power to the high-frequency power source by controlling the plurality of first variable capacitors or the second variable capacitor.

18. The substrate processing apparatus of claim 17, further comprising:
a substrate support unit by which the substrate is supported; and
a driving unit configured to move the substrate support unit in a second direction crossing the first direction.
